(19) United States
(12) Patent Application Publication
(10) Pub. No.: US 2005/0156688 A1
(43) Pub. Date: Jul. 21, 2005

(54) Dielectric waveguide filter

(75) Inventors: Masaharu Ito, Tokyo (JP); Kenichi Maruhashi, Tokyo (JP); Keiichi Ohata, Tokyo (JP)

Correspondence Address: WHITHAM, CURTIS & CHRISTOFFERSON, P.C., 11491 SUNSET HILLS ROAD, SUITE 340, RESTON, VA, 20190, US

(73) Assignee: NEC Corporation, Tokyo (JP)

(21) Appl. No.: 10/502,782

(22) PCT Filed: Jan. 31, 2003
(86) PCT No.: PCT/JP03/00982

(30) Foreign Application Priority Data
Feb. 4, 2002 (JP) 2002-027072

(51) Int. Cl. H01P 1/208

(52) U.S. Cl. 333/208; 333/212

(57) ABSTRACT

A conductive layer is formed on each of the upper and lower surfaces of a dielectric substrate, and the two conductive layers are connected by rows of via-holes that are formed which a spacing that is less than or equal to ½ of the wavelength in the dielectric substrate in the resonance frequency, whereby n stages of dielectric resonators and input/output waveguide structures are formed. If the number n of stages is assumed to be 3, the first-stage resonator and the second-stage resonator are coupled by an electromagnetic field by means of via-holes of a first spacing; the second-stage resonator and the third-stage resonator are coupled by an electromagnetic by means of via-holes of a second spacing, whereby a filter is formed. The input/output waveguide structure and the filter are coupled by an electromagnetic by means of via-holes of a fourth spacing. The first-stage resonator and the third-stage resonator are coupled by an electromagnetic field by means of via-holes of a third spacing.

### TECHNICAL FIELD

The present invention relates to a dielectric waveguide filter that has an upper conductive layer and a lower conductive layer on the surfaces of a dielectric substrate, wherein a row of via-holes or conductors that connect the upper conductive layer and lower conductive layer is used to form resonators and dielectric windows.

### BACKGROUND ART

There exists a need for filters that feature low loss and a steep out-of-band suppression characteristic, and further, that feature compact size and connectability with a planar circuit. From the standpoint of connection reproducibility and low parasitic inductance at high frequencies, it is also strongly desired that such filters allow flip-chip packaging. One filter having these characteristics is shown in FIG. 1 and described in the public literature in a paper by M. Ito et al. (IEEE International Microwave Symposium Digest, pp. 1597-1600, May 2001). FIG. 1A is a plan view of this known example of a filter, and FIG. 1B is a sectional view taken along alternate long and short dash line E-E′ in FIG. 1A. Conductive layers 2a and 2b are formed on the upper and lower surfaces of dielectric substrate 1, and these upper and lower conductive layers 2a and 2b are connected by via-hole rows 3a that are formed such that spacing Ip in the direction of signal propagation is less than or equal to ½ of the guide wavelength, whereby a waveguide is formed. A waveguide filter is achieved by forming via-holes 3b that constitute dielectric windows within this waveguide at spacing I₁, I₂, I₃, I₄ that is equal to or less than ½ of the guide wavelength. In addition, waveguide-coplanar converters 10 are formed over the first-stage and final-stage resonators, these waveguide-coplanar converters being connected to input/output coplanar lines that are made up of ground conductive layer 2a and signal conductive layer 2c. Finally, to improve the out-of-band suppression characteristic, coplanar resonators 15 that provide a bandwidth elimination characteristic are connected to waveguide-coplanar converters 10.

When fabricating the filter of the above-described known example using a ceramic as the dielectric substrate, via-holes were formed by punching before sintering the green sheet, and a conductive pattern was formed after sintering. As a result, misregistration between the via-holes and the conductive pattern tends to occur due to the degree of control of the coefficient of contraction during sintering. With the filter of this known example, due to a coupling by an electromagnetic field between coplanar resonators 15 and the dielectric resonators that constitute the filter, the filter characteristics are highly sensitive to misregistration between via-holes 3a and 3b and upper conductive layer 2a, as shown in FIG. 6. As a consequence, problems are encountered in fabrication such as a high degree of variability in performance and low yield.

### DISCLOSURE OF THE INVENTION

It is an object of the present invention to provide a dielectric waveguide filter that is capable of forming out-of-band attenuation poles without additionally forming openings for interlaced electromagnetic field coupling.

According to a first aspect of the invention, in a dielectric waveguide filter that has an upper conductive layer and a lower conductive layer on surfaces of a dielectric substrate, and conductors that connect the upper conductive layer and the lower conductive layer to form resonators and dielectric windows, the number n of filter stages is 3 or more, and a first to nth resonators are successively coupled by electromagnetic fields such that the i^{th} resonator is coupled to the j^{th} resonator by an electromagnetic field, where j≠i±1.

By two-dimensionally arranging resonators that are surrounded by via-holes, out-of-band attenuation poles can be formed without additionally providing openings for interlaced electromagnetic field coupling. As a result, the out-of-band suppression characteristic can be improved, the number of filter stages can be reduced, and a more compact device can be realized.

The formation of waveguide-coplanar converters on the dielectric resonators of the input and output stages of the filter enables flip-chip packaging. In addition, there is no need for providing openings on resonators other than the input and output stages, and this configuration is therefore less prone to misregistration between the conductive layers and via-holes during fabrication.

According to an embodiment of the present invention, resonators are formed by rows of via-holes that connect the upper and lower conductive layers that are formed on the surfaces of the dielectric substrate, and the spacing of the via-holes that form the via-hole rows is less than or equal to ½ of the guide wavelength of the resonance frequency.

According to an embodiment of the present invention, planar lines made up of slots are formed on the upper conductive layer and/or the lower conductive layer on the surfaces of the dielectric substrate.

According to another embodiment of the present invention, the planar lines are coplanar lines made up of two coupled slots.

According to another aspect of the present invention, in a dielectric waveguide filter that has an upper conductive layer and a lower conductive layer on the surfaces of a dielectric substrate, and rows of via-holes that connect the upper conductive layer and the lower conductive layer to form resonators and dielectric windows, the spacing of the via-holes that form via-hole rows is equal to or less than ½ of the waveguide wavelength of the resonance frequency, and for at least one via-hole of the via-hole rows, a slot is formed so as to surround the periphery of the via-hole in the upper conductive layer and/or the lower conductive layer, and a conductive tab is used to connect the two conductive layers each other across the slot.

According to an embodiment of the present invention, the filter is flip-chip packaged, and conductive tab and bumps that are formed on the substrate for flip-chip packaging are used to connect the conductive layers on both sides across slots that are formed surrounding the peripheries of via-holes.

According to an embodiment of the present invention, the number n of filter stages is 3 or more, and the first to n^{th} resonators are successively coupled by electromagnetic fields such that the i^{th} resonator is coupled to the j^{th} resonator by an electromagnetic field, where j≠i±1.

According to an embodiment of the present invention, planar lines are made up of slots are formed in the upper conductive layer and/or the lower conductive layer on the surfaces of the dielectric substrate.

According to the embodiment of the present invention, the planar lines are coplanar lines made up of two coupled slots.

### BRIEF DESCRIPTION OF THE DRAWINGS

FIG. 1 shows the configuration of a waveguide filter of the prior art, FIG. 1A being a plan view of the filter substrate, and FIG. 1B being a sectional view taken along alternate long and short dash line E-E′ of FIG. 1A;

FIG. 2 shows the configuration of a first embodiment according to the present invention, FIG. 2A showing a plan view of the filter substrate and FIG. 2B showing a sectional view taken along alternate long and short dash line A-A′ of FIG. 2A;

FIG. 3 shows the configuration of a second embodiment according to the present invention, FIG. 3A showing a plan view of the filter substrate, FIG. 3B showing a detailed view of an inductance regulator, and FIG. 3C showing a sectional view taken along alternate long and short dash line B-B′ of FIG. 3B;

FIG. 4 shows the configuration of a third embodiment according to the present invention, FIG. 4A showing a plan view of the filter substrate, and FIG. 4B showing a sectional view taken along alternate long and short dash line C-C′ of FIG. 4A;

FIG. 5 shows the configuration of a fourth embodiment according to the present invention, FIG. 5A showing a plan view of the filter substrate, FIG. 5B showing a detailed view of an inductance regulator, and FIG. 5C showing a sectional view taken along alternate long and short dash line D-D′ of FIG. 5B;

FIG. 6 shows the change in characteristic with respect to the misregistration of via-holes and conductive pattern in the filter of the prior art shown in FIG. 1;

FIG. 7 shows the improvement of the out-of-band suppression characteristic realized by the present invention; and

FIG. 8 shows the change in characteristic with respect to misregistration between via-holes and conductive pattern in a filter of the present invention.

### BEST MODE FOR CARRYING OUT THE INVENTION

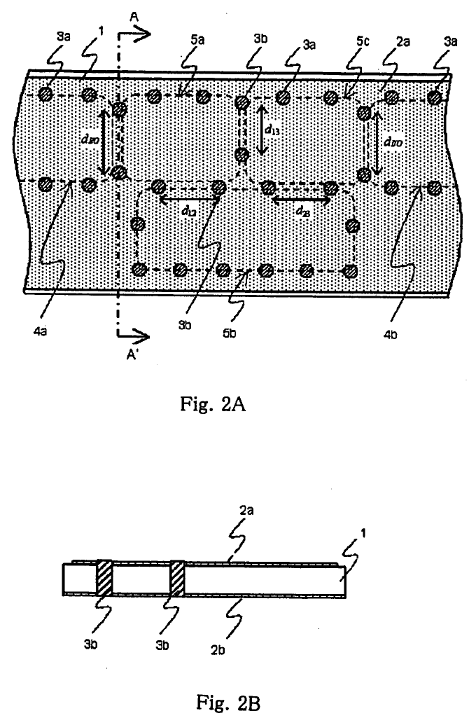

A first embodiment according to the present invention will now be explained in detail with reference to FIG. 2. FIG. 2A is a plan view of a filter substrate, and FIG. 2B is a sectional view taken along alternate long and short dash line A-A′ in FIG. 2A.

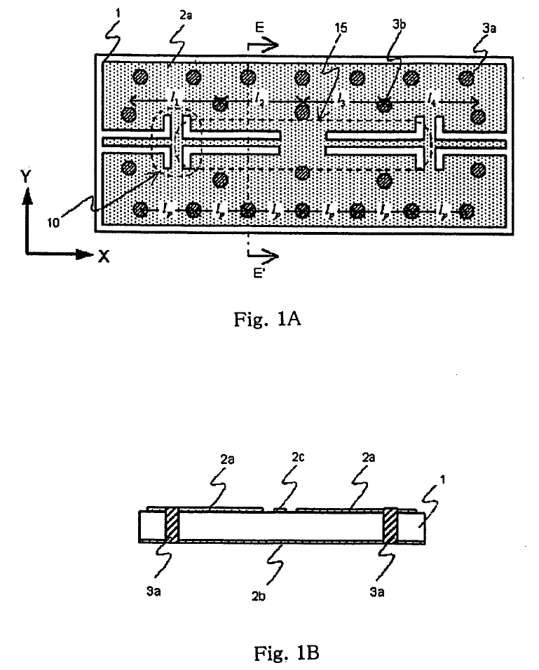

Upper and lower conductive layers 2a and 2b are formed on the upper and lower surfaces of dielectric substrate 1. Upper and lower conductive layers 2a and 2b are connected each other by via-hole rows 3a and 3b that are formed with a spacing being equal to or less than ½ of the wavelength in the dielectric substrate at the resonance frequency, whereby first-stage, second-stage, and third-stage dielectric resonators 5a, 5b, and 5c and input/output waveguide structures 4a and 4b are formed. The filter is configured such that first-stage resonator 5a and second-stage resonator 5b are coupled by an electromagnetic field by means of dielectric windows in the form of via-holes 3b with a spacing being equal to d₁₂ and second-stage resonator 5b and third-stage resonator 5c are coupled by an electromagnetic field by means of dielectric windows in the form of via-holes 3b with a spacing being equal to d₂₃. Input/output waveguide structures 4a and 4b and the filter are electromagnetically coupled by dielectric windows in the form of via-holes 3b with a spacing being equal to d_{I/O}. Two-dimentional arrangement of resonators 5a, 5b, and 5c makes it possible to easily provide coupling by an interlaced electromagnetic field between first-stage resonator 5a and third-stage resonator 5c by means of dielectric windows in the form of via-holes 3b with a spacing being equal to d13. This allows to provide an attenuation pole on the high-frequency side of the pass band, as shown by the transmission characteristic of the filter in FIG. 7, thus improving the out-of-band suppression characteristic. The filter described in the public document shown in FIG. 1 has openings formed thereon that function as coplanar resonators 15 to introduce attenuation poles on the resonators that form the filter, but the filter of the present invention lacks these openings. Thus, as shown in FIG. 8, change in characteristic resulting from misregistration of via-holes 3a and 3b with respect to conductive layer 2a can be adequately controlled. In addition, the filter of the present embodiment can realize coupling by an interlaced electromagnetic field by only the arrangement of via-holes and therefore does not require additional fabrication steps.

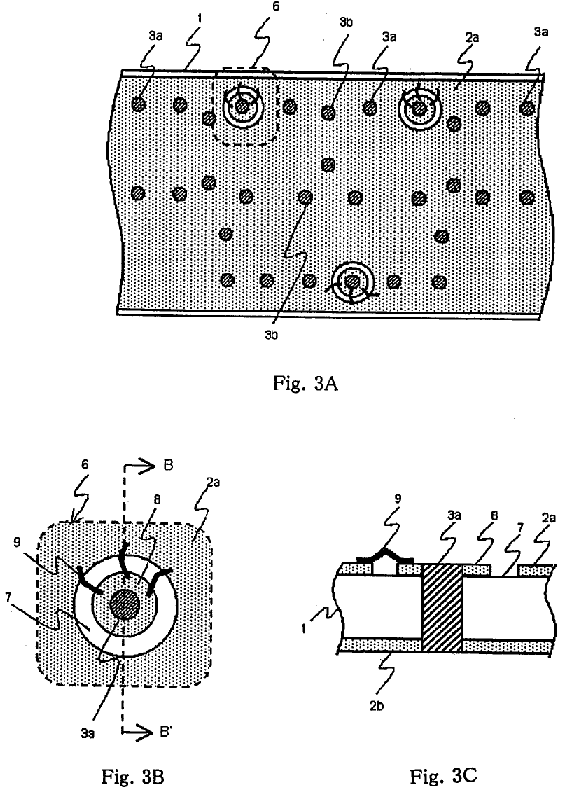

As a second embodiment of the present invention, a configuration that allows regulation of the filter characteristics will be explained with reference to FIG. 3. FIG. 3A is a plan view of the filter substrate, FIG. 3B is a detailed view of the area 6 enclosed by the dotted lines in FIG. 3A, and FIG. 3C is a sectional view taken along alternate long and short dash line B-B′ in FIG. 3B.

Forming slot 7 around the periphery of via-hole 3a that forms a resonator causes pad 8 to be formed that is electrically isolated from conductive layer 2a. This pad 8 and conductive layer 2a are connected each other by, for example, bonding wires 9. The number of wires or their length are regulated to form inductance regulator 6 for regulating the inductance of via-holes 3a that form the side walls of the dielectric resonator. Changes in the inductance change the resonance frequency of the dielectric resonator. Accordingly, forming inductance regulator 6 in each resonator stage enables regulation of the center frequency of the filter. In addition, forming inductance regulators 6 at via-holes 3b that form the dielectric windows enables regulation of the degree of electromagnetic field coupling between dielectric resonators. In such a case, the bandwidth of the filter can be regulated.

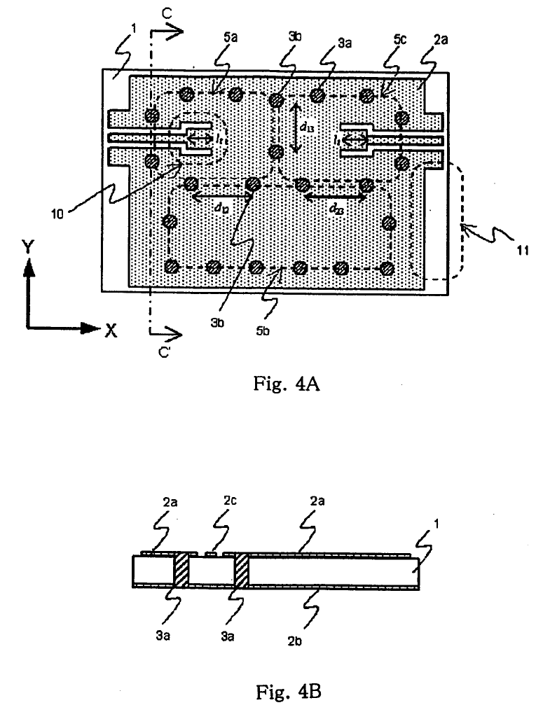

A third embodiment of the present invention will now be explained in detail with reference to FIG. 4. FIG. 4A is a plan view of the filter substrate, and FIG. 4B is a sectional view taken along alternate long and short dash line C-C′ in FIG. 4A.

Upper and lower conductive layer 2a and 2b are formed on the surfaces of dielectric substrate 1. First-stage, second-stage, and third-stage dielectric resonators 5a, 5b, and 5c are formed by connecting these upper and lower conductive layers 2a and 2b by means of via-hole rows 3a and 3b that are formed with a spacing being equal to or less than ½ of the wavelength in the dielectric substrate at the resonance frequency. Formed on first-stage resonator 5a and third-stage resonator 5c are waveguide-coplanar converters 10 that are connected to input/output coplanar lines that are made up of ground conductive layer 2a and signal conductive layer 2c. The degree of electromagnetic field coupling between input/output stage resonators 5a and 5c and waveguide-coplanar converters 10 is regulated by the length Iₜ of waveguide-coplanar converters 10. The filter is configured such that first-stage resonator 5a and second-stage resonator 5b are coupled by an electromagnetic field by means of dielectric windows in the form of via-holes 3b with a spacing being equal to d₁₂, and the electromagnetic field second-stage resonator 5b and third-stage resonator 5c are coupled by dielectric windows in the form of via-holes 3b with a spacing being equal to d₂₃. The two-dimensional arrangement of resonators 5a, 5b, 5c makes it possible to provide an interlaced electromagnetic field coupling between first-stage resonator 5a and third-stage resonator 5c by means of the dielectric windows in the form of via-holes 3b with a spacing being equal to d₁₃. The provision of notches 11 in conductive layer 2a of the input/output portions enables a reduction of the emission at the end of the substrate. The adoption of coplanar lines for input and output enables integration of planar circuit such as MMIC (Monolithic Microwave Integrated Circuit) and also enables flip-chip packaging.

In this case as well, the use of a configuration that is similar to the second embodiment allows regulation of the filter characteristics, and the adoption of coplanar lines for input and output further facilitates flip-chip packaging.

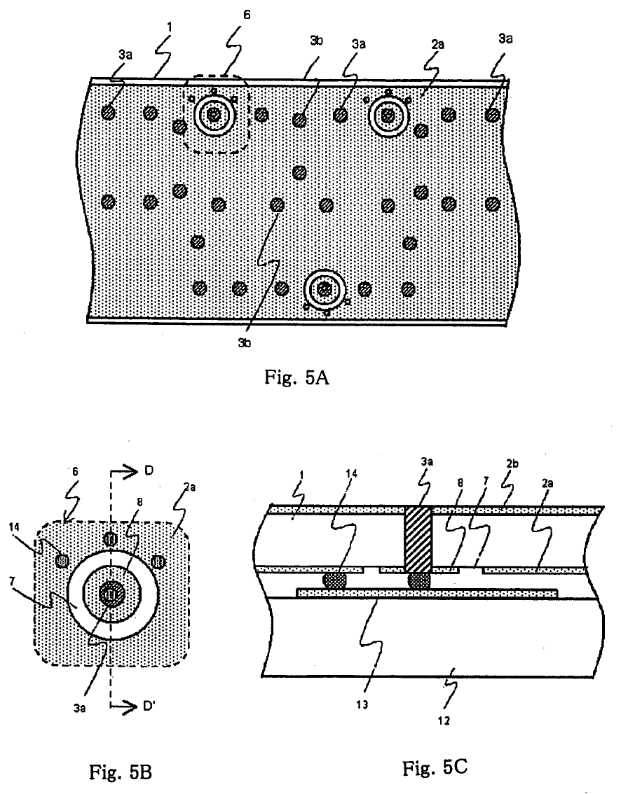

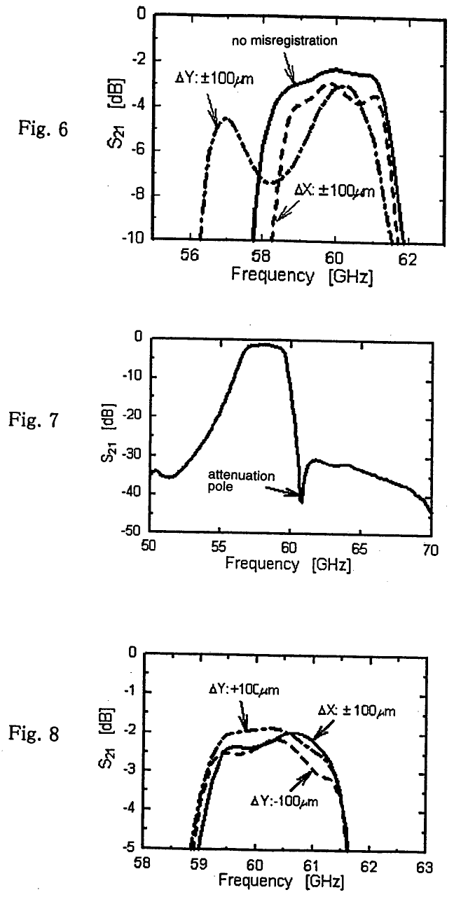

As a fourth embodiment of the present invention, a configuration that regulates filter characteristics using flip-chip packaging, will now be explained with reference to FIG. 5. FIG. 5A is a plan view of the filter substrate, FIG. 5B shows the details of area 6 that is delineated by dotted lines in FIG. 5A, and FIG. 5C is a sectional view taken along alternate long and short dash line D-D′ in FIG. 5B. For the sake of illustration, however, flip-chip packaging substrate 12 is not shown in FIGS. 5A and 5B.

Forming slot 7 around the periphery of via-hole 3a that forms a resonator causes pad 8 to be formed that is electrically isolated from conductive layer 2a. This pad 8 and conductive layer 2a are connected each other by way of bump 14 and conductive layer 13 that is formed on flip-chip packaging substrate 12, whereby the same effect as the second embodiment can be obtained. In addition, this embodiment provides the additional advantage that the filter characteristics can be adjusted when the filter substrate undergoes flip-chip packaging, thus eliminating additional frequency adjustment steps.

Although examples have described in the above-described embodiments in which the number of filter stages was three, the number of stages may be increased to obtain the desired characteristics. In addition, a configuration for regulating the inductance of the via-holes can also be applied to the frequency regulation of a single resonator that is used in a dielectric resonator/oscillator.

1. A dielectric waveguide filter, comprising:
an upper conductive layer and a lower conductive layer on surfaces of a dielectric substrate; and
conductors for connecting said upper conductive layer and said lower conductive layer to form resonators and dielectric windows;
wherein the number n of filter stages is 3 or more, and a first to n^{th} resonators are successively coupled by electromagnetic fields such that the i^{th} resonator is coupled by an electromagnetic field to the j^{th} resonator, where j≠i±1.

2. The filter according to claim 1, wherein said resonators are formed by via-hole rows that connect said upper conductive layer and said lower conductive layer, and the spacing of via-holes that form said via-hole rows is less than or equal to ½ of the guide wavelength of the resonance frequency.

3. The filter according to claim 1, wherein planar lines made up of slots are formed on said upper conductive layer and/or said lower conductive layer.

4. The filter according to claim 3, wherein said planar lines are coplanar lines made up of two coupled slots.

5. The dielectric waveguide filter, comprising:
an upper conductive layer and a lower conductive layer on surfaces of a dielectric substrate; and
rows of via-holes that connect said upper conductive layer and said lower conductive layer to form resonators and dielectric windows;
wherein spacing of said via-holes that form said via-hole rows is less than or equal to ½ of the guide wavelength of the resonance frequency, for at least one via-hole of said via-hole rows, a slot is formed so as to surround the periphery of said via-hole in the upper conductive layer and/or said lower conductive layer, and a conductive tab is used to connect said two conductive layers each other across said slot.

6. The filter according to claim 5, wherein said filter undergoes flip-chip packaging, and conductive tabs and bumps that are formed on the substrate for flip-chip packaging are used to connect the two conductive layers across slot that are formed surrounding the peripheries of via-holes.

7. The filter according to claim 5, wherein the number n of filter stages is 3 or more, and the first to n^{th} resonators are successively coupled by electromagnetic fields such that the i^{th} resonator is coupled to the j^{th} resonator by an electromagnetic field, where j≠i±1.

8. The filter according to claim 5, wherein planar lines made up of slots are formed in said upper conductive layer and/or said lower conductive layer.

9. The filter according to claim 8, wherein said planar lines are coplanar lines made up of two coupled slots.
